(19) United States
(12) Patent Application Publication
(10) Pub. No.: US 2011/0240644 A1
(43) Pub. Date: Oct. 6, 2011

(54) THERMOPLASTIC CONTAINERS WITH EASY ACCESS DEFINED BY LASER-INDUCED RUPTURABLE AREAS

(76) Inventors: Steven Donald Kimmell, Simi Valley, CA (US); Arthur Barukh, Simi Valley, CA (US); James Louis Cabernoch, Altadena, CA (US); Glenn Roy Detlor, Monument, CO (US)

(21) Appl. No.: 13/079,212

(22) Filed: Apr. 4, 2011

Related U.S. Application Data
(60) Provisional application No. 61/341,789, filed on Apr. 5, 2010.

(51) Int. Cl. B65D 41/32; B29C 35/08; B29C 51/00

(52) U.S. Cl. 220/266; 264/400

(57) ABSTRACT

A thermoformed or vacuum-formed plastic container packaging including a laser energy-induced internal rupturable area disposed between the topside and the bottomside of the plastic material. A pattern in structural communication with the laser-induced rupturable area enables the user's hands to apply a focused shearing force on the area for fracturing and opening the plastic material container. The rupturable area is configured such that an exerted shearing force exposes a haptically smooth fractured edge to the user. Two rupturable areas may be disposed such that two parallel patterns configure a tear strip or a pull-tab. Multiple rupturable areas are disposed such that parallel and attachable patterns configure protective covers or tear strip ends. Die cutout patterns configure notches or voids attached to said laser-induced rupturable area.

### REFERENCE TO RELATED APPLICATIONS

This application claims priority from U.S. Provisional Application Ser. No. 61/341,789 filed on Apr. 5, 2010 and this reference is incorporated herewith in its entirety.

### BACKGROUND OF INVENTION

Specifically, the present invention relates a laser energy-induced internal rupturable area disposed between the topside and the bottomside of the plastic to enable the user to manually tear, bend, fracture, and separate the plastic material. More specifically, the present invention relates a pattern in structural communication with the laser-induced rupturable area, for enabling the user's hands to apply an exerted shearing force exposing a haptically smooth fractured edge for opening the plastic container packaging while maintaining the integrity of the container.

Modern packaging resins are generally thermoformed and welded shut by direct application of heat, radio-frequency energy and bonding agents including glues, solvents, and cements. Once sealed these packages are airtight and difficult to open requiring the end user to use scissors, knives, or blunt objects to access the contained product. Further, upon opening, this type of packaging becomes dangerous to the end user because it exposes razor-sharp, jagged, and barbed edges and burrs of the fractured and opened packaging material. Blister packs are typical integuments for containing technical devices, medicaments, commercial and consumer products, for the purposes of making the enclosed goods visible to the user and maintaining sealed and secured contents. Another example of secure packaging is known as a clamshell container. It is desirable to prevent pilferage at the point of sale and to protect the contents from moisture and contamination. It is often necessary for end users to employ tools, blades, scissors, sharp knives, shears, or blunt objects to breach the clamshell container and to remove the goods contained therein. Thousands of injuries related to the use of such tools to remove items from modern, highly-polished clamshell packaging are reported by hospital emergency rooms, consumer product industries, and medical, industrial, and military application groups.

The present invention discloses packaging that provides easy access to the contents, such as medical fluids, chemical substances, toys, food products, hardware components, computer devices, house wares or other consumer products, while maintaining secured packaging containers through the distribution system.

Existing packaging with easy access features relies on perforated or cut plastic or cardboard. Such features are often pressed or imposed with matched-metal dies or rule dies which are fast wearing and require maintenance and replacement at frequent intervals. Inadequate maintenance of these dies results in incomplete perforation of packaging material and unsatisfactory performance when opening or separating portions of plastic packaging container materials.

Devices other than dies cut and weld materials, for example laser cutting and welding devices for etching images in solid articles is described in U.S. Pat. No. 5,575,936 to Goldfarb, entitled Process And Apparatus For Etching An Image Within A Solid Article, this patent being incorporated herein by this specific reference. In accordance with the invention, laser energy disrupts glass at a focal point in the solid to cut, weld, drill, and to imprint using computer control which recognizes the edges and center of the article to appropriately coordinate the operation of the movable platform and the laser, thus placing and centering the image.

An example of an ultrashort pulse laser device for welding, scribing, cutting, grooving and cleaving facets in solid transparent material is described in U.S. Pat. No. 7,626,138 to Bovatsek entitled Transparent Material Processing With An Ultrashort Pulse Laser, this patent being incorporated herein by this specific reference. In accordance with the invention, a user scribes and shapes brittle substances with a laser cutting device for cleaving, joining multiple materials, perforating material, marking subsurface material for creating clearly visible marks with side-illumination, and dicing solid material by scribing a surface groove using an ultrashort laser pulse and then applying a mechanical saw blade to complete the cut is presented.

Another useful method and laser system for controlling breakdown processes, development and space structure of laser radiation, and for producing high quality laser induced damage images and is described in U.S. Pat. No. 6,720,521 to Troitski entitled Method And Laser System Controlling Breakdown Process Development And Space Structure Of Laser Radiation For Production Of High Quality Laser-Induced Damage Images. In this invention, the laser apparatus creates points of damage to transparent material by creating a plasma with multiple laser pulses and a shock wave in the material to make subsurface markings and shadows by cutting tiny perforations into the material and for producing an optical effect image in the material.

A useful laser method for perforating and sealing packaging layers is described in a method for manufacture of a pack for preservation treatment of foodstuffs and dry mixes in U.S. Pat. No. 6,427,420 to Oliveri et.al. entitled Method For The Manufacture Of A Laser-Precut Pack And Pack. Gusset or flat bag package assemblies include two plastic layers for inner and outer faces of the pack and a light metal central layer sandwiched between the plastic layers. Laser energy is applied to the lower layer of a plastic film, which forms the inner layer of the package, for forming precut lines and a perforations extending over the width of the pack. The multiple layers of the gusset bag are then laser welded together after all the edges are precut and formed.

### SUMMARY OF THE INVENTION

In accordance to the present invention the structural integrity of the single-material thermoplastic container is maintained until the laser-induced rupturable area patterns in the material are fractured and separated. When the stress profile within a thermoformed plastic part is known, adjustments in the physical processing, material preparation, or part design may be made to eliminate these stresses or reduce them to an acceptable levels, for example: humidity or moisture content, impact velocity or strain rate, geometry, how the sample is prepared (formulated, molded, extruded, or fabricated), sample-notching procedures, stress due to cooling rates, non-uniform temperature or flow rates, material contaminants, mechanical loading, thermal cycling during transport and storage, inadequate or non-uniform annealing, and sharp corners or protrusions that cause localized stress concentrations.

The thermo-formed plastic container pattern may include a pull-tab, tear strip, tear strip ends, protective cover, a notch or void, or other such pattern feature for enabling the user to manually tear, bend, fracture, and separate the plastic material. Two rupturable areas may be disposed such that two parallel patterns configure a tear strip or a pull-tab. Multiple rupturable areas are disposed such that parallel and attachable patterns configure protective covers or tear strip ends. Die cutout patterns configure notches or voids attached to said laser-induced rupturable area.

The present invention provides for a thermoformed or vacuum-formed plastic container packaging for enabling users to manually apply force to open the container. A thermoformed or vacuum-formed plastic container packaging including a laser energy-induced internal rupturable area disposed between the topside and the bottomside of the plastic material. A pattern in structural communication with the laser-induced rupturable area enables the user's hands to apply a focused shearing force on the area for fracturing and opening the plastic material container. The rupturable area is configured such that an exerted shearing force exposes a haptically smooth fractured edge to the user.

The present invention provides for a thermoformed or vacuum-formed plastic container packaging with a laser energy-induced internal rupturable area disposed between the topside and the bottomside of the material for configuring a pattern in structural communication with the laser-induced rupturable area. The laser-induced rupturable area and pattern are configured such that an exerted shearing force enabled by the user's hands exposes a haptically smooth fractured edge of the material.

Accordingly, in accordance with the present invention laser-induced internal rupturable areas are disposed between the topside and the bottomside of the plastic material, within the material itself, or within the wall thickness of the material. A pattern in structural communication with the laser-induced rupturable area is configured such that an exerted shearing force enabled by the user's hands exposes a haptically smooth fractured edge of the material. The customer or user haptically or cutaneously grasps, senses, or touches the fractured or broken edge and the skin perceives or knows smoothness or sharpness of the fractured material.

The laser-induced rupturable area is configured for enabling the user's hands to apply a focused shearing force on the area for fracturing and separating the package material without the use of tools, blades, scissors, or blunt objects while maintaining the integrity of the container material in the distribution system. Preferably the exerted shearing force is focused at the end of the laser-induced patterns for bending and breaking the plastic material and for imparting to the user a haptically smooth fractured edge.

More specifically, two laser-induced rupturable areas in the plastic material may be disposed to configure two parallel patterns with a tear strip therebetween. Two parallel laser-induced patterns may configure tear strips, tear strip ends, pull-tabs, notches or voids. A tear strip encompassing the perimeter, or extended length of the container, may “zip” apart the single-material or the upper and lower clamshell portions of a plastic container package when engaged with a shearing force concentrated at the end of a rupturable area, for example pulling the end of a pull-tab attached to the tear strip.

Alternatively, multiple short parallel laser-induced patterns may configure protective covers for tear strips and tear strip ends. Upon flexing the multiple parallel patterns, the short patterns separate exposing the ends of the tear strips.

Preferably the plastic container is a clamshell or blisterpack container. The present invention includes plastic material thermoformed or vacuum-formed typically selected from polyvinyl chloride, polyethylene terephthalate, and glycol modified polyethylene terephthalate, and other applicable types of plastic materials.

Even more specifically, a die cutout configured notch or void connectably attached to the laser-induced internal rupturable areas disposed between the topside and the bottomside of the material imparts openings to the plastic material container configurations. Such patterns and designs provide structural communication with a laser-induced patterns for enabling the user to manually apply a focused shearing force on the pattern for fracturing and separating the container. Preferably the exerted shearing force is focused at the end of the laser-induced rupturable area for bending and breaking the container and for imparting to the user a haptically smooth fractured edge along the laser-induced fracturable plane.

Alternatively, the plastic container described hereinabove is suitable for performing a method, in accordance with the present invention, for configuring a thermoformed or vacuum-formed plastic container with laser-induced rupturable areas, comprising the steps of:

(a) applying laser energy for inducing an internal rupturable area disposed between the topside and the bottomside of said plastic container material;

(b) communicating structurally a pattern with the laser-induced rupturable area for enabling the user's hands to apply a focused shearing force on the area for fracturing and opening said material;

(c) exerting a shearing force on said configured rupturable area for exposing a haptically smooth fractured edge;

(d) encompassing the perimeter of the plastic container with a tear strip configured by two parallel patterns;

(e) forming a protective cover and tear strip ends by configuring adjacently parallel and attachably disposed patterns;

(f) forming a pull-tab by configuring said parallel patterns;

(g) configuring a notch or void die cutout attached to laser-induced rupturable areas.

(h) encompassing a portion of the perimeter of the plastic container with a tear strip configured by two parallel laser-induced patterns.

A thermo-formed or vacuum-formed plastic container, comprising an upper portion and a lower portion, includes a laser energy-induced internal rupturable area disposed between the topside and the bottomside of the material for configuring a pattern in structural communication with the laser-induced rupturable area. The laser-induced rupturable area and pattern are configured such that an exerted shearing force enabled by the user's hands exposes a haptically smooth fractured edge of the material.

### BRIEF DESCRIPTION OF THE DRAWINGS

The advantages and features of the present invention will be better understood by the following description when considered in conjunction with the accompanying drawings, in which:

FIGS. 1 and 2 are respective views of prior art blister packaging devices which often present difficult and sometimes hazardous removal of items by a user;

FIG. 3 illustrates a cross section view of the plastic wall and showing a laser energy-induced rupturable area disposed between the topside and the bottomside of plastic material in accordance with the present invention.

FIG. 4 is a perspective view of a container made with a material in accordance with the present invention and illustrates package opening with haptic surfaces.

FIG. 5 illustrates a perspective view of a welded upper portion and lower portion of clamshell container in accordance with the present invention, including laser-induced parallel patterns two of the pattern defining a tear strip therebetween for encompassing a predetermined portion of the clamshell and for opening the perimeter of the container upon applying a pulling force. A protective cover initiating feature includes multiple parallel patterns for exposing the tear strip ends upon flexing and fracturing;

FIG. 6 illustrates a top view of a die cutout configured notch or void connectably attached to the patterns. The force-concentrating notch or voids are accurately positioned to focus opening shearing force at the ends of the laser-induced patterns between the topside and the bottomside of the plastic material in accordance with FIG. 5;

FIG. 7 illustrates a perspective view of a clamshell container upper portion including a finger size die-cutout notch or void for providing access to a pull-tab pattern in accordance with FIGS. 5 & 6;

FIG. 8 illustrates a perspective view of a thermoformed clamshell package including a connectably large notch or void, two laser-induced transverse tear strip patterns, and attachable pull-tab patterns for opening the container. The pull-tabs are accessed by the user through a finger notch or void and pulled to exert shearing force at the fixed force concentrator (in accordance with FIGS. 6 and 7) separating the tear strips and freeing the package end to be rotated downward; and

FIG. 9 illustrates a perspective view, in accordance with the invention, a clamshell package wherein a lower portion of the clamshell is welded to an upper portion by using thermal or radio-frequency techniques. Two laser-induced rupturable areas located on the flange rim are disposed such that two parallel patterns configure pull-tab ends. A laser-induced rupturable pattern disposed through the upper shell attaches the initial pull-tab sections. Two laser-induced parallel patterns are disposed with a tear strip therebetween for encompassing a portion of the perimeter of the packaging material. When the user flexes the flange, the exposed end of the initial pull-tab can be grasped, pulled upward, and the shearing force applied by the user “zips” the tear strip off the package perimeter. This “zipper” pull tab provides direct access to the laser-induced pattern and enables opening of the container with the force of a user's hands;

### DETAILED DESCRIPTION

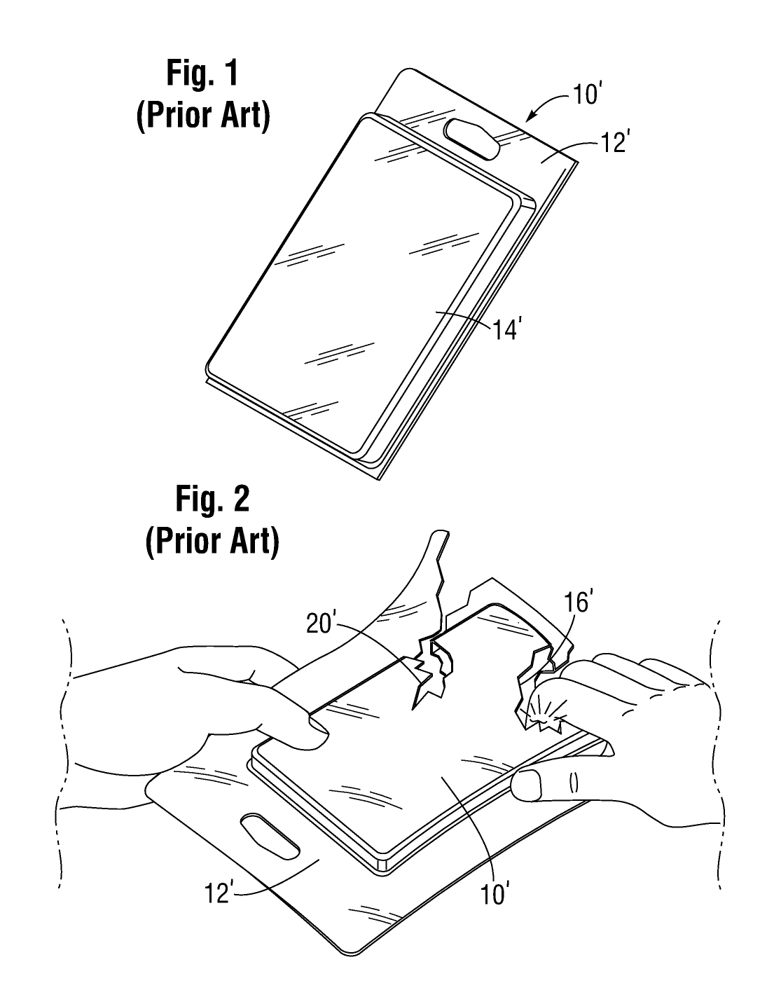

With reference to FIG. 1, there is shown a prior art plastic clam shell container, or blister pack, 10′ having a back sheet 12′ and a cover 14′ for enclosing a product (not shown) therebetwen.

Materials of construction may be thermal formed or vacuumed-formed materials selecting from a group comprising polyvinyl chloride, polyethylene terephthalate, and glycol modified polyethylene terephthalate. It should be appreciated that any suitable materials may be utilized in the present invention.

FIG. 2 is a perspective view of the container 10′ shown in FIG. 1 as it may be manually opened by a user's fingers 16. Although a tool (not shown) may be utilized to separate the material 14′, such fracture or separation still usually results in dangerous razor-sharp, jagged and/or barbed edgesm, and burrs 20′.

The present invention eliminates this problem associated with prior art containers 10′.

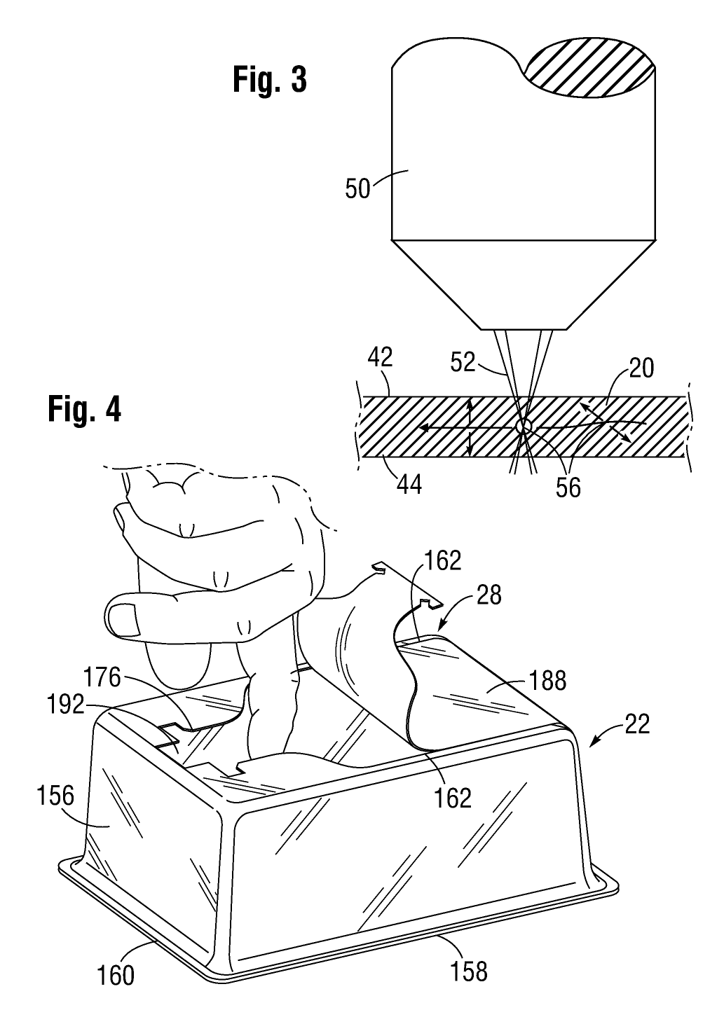

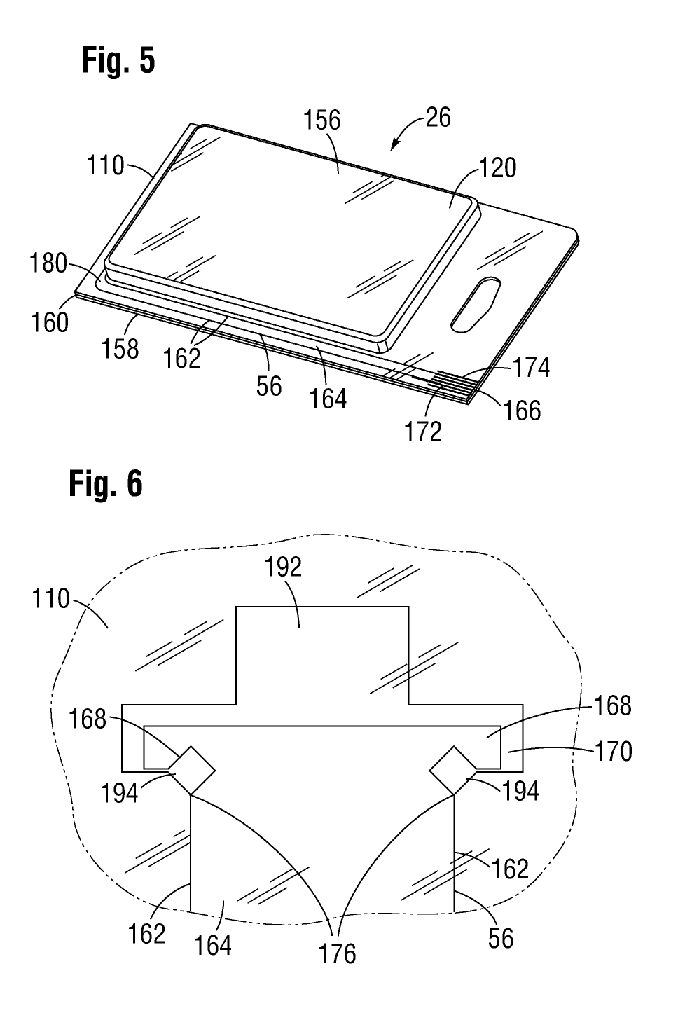

With reference to FIG. 3, there is shown a plastic material 20 in accordance with the present invention suitable for forming clam shells 26, 28, 30 shown respectively in FIGS. 5, 7, and 8.

As illustrated in FIG. 3, the material 20 includes a topside 42 and a bottom side 44. A laser 50 via a laser beam 52 induces an internal rupturable area 56 disposed between the topside 42 and bottom side 44 of the material 20.

This rupturable area 56 enables a manually applied shearing force to expose a haptically smooth fractured edge 58, see FIG. 4. The term haptic, or haptically, in accordance with the present invention, is meant to mean smooth, uniform and unbroken, such as for example, a surface free from roughness, or bumps, or ridges, or irregularities. Thus, a haptic surface is the antithesis of surfaces produced by the rupture or separation of conventional blister pack.

A laser apparatus for use in the present invention include laser apparatus and controllers for cutting and etching images within solids by laser light as is described in U.S. 5,575,935 to Goldfarb, which is incorporated herein its entirety. Additional teachings with regard to lasers for welding, scribing, clean braking, cutting, grooving, and cleaving facets and solids by laser light are described in U.S. 7,626,138 to Bovatsek. Again, this reference is incorporated herewith by this specific reference thereto.

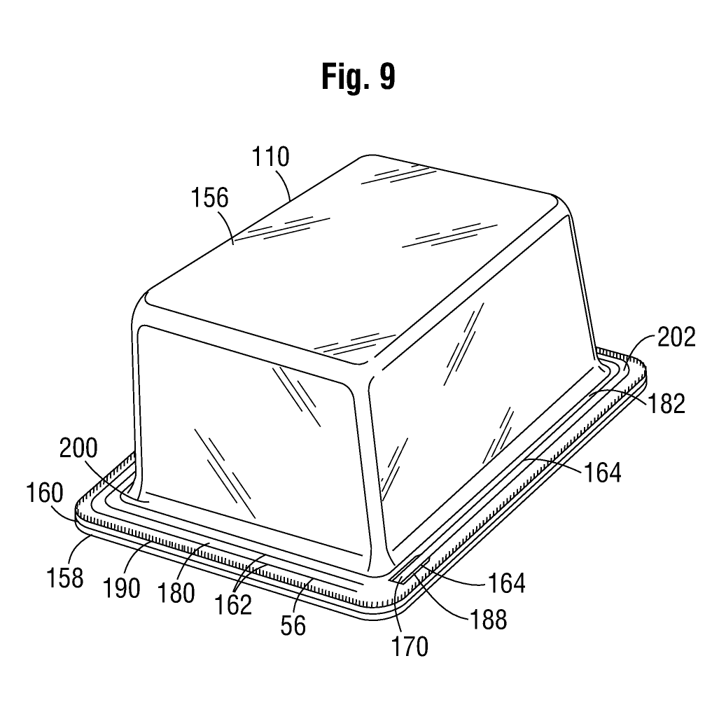

As seen in FIGS. 5, 7, 8, 9, and as best seen in FIG. 5, a welded 160 upper portion 156 and lower portion 158 of clamshell container 110 or blisterpack 120 packaging container. In accordance with the present invention, two multiple laser-induced parallel patterns 162 create a tear strip 164 therebetween encompass 180 a portion of the clamshell perimeter 182 (FIGS. 5 and 9) for separating the container portions. Multiple rupturable areas disposed 172 such that adjacently parallel 178 and attachably disposed patterns 176 configure a protective cover 174 and the tear strip ends 166. The user manually enables shearing force 122 focused at the end of the laser-induced tear strip patterns 166, and upon flexing and fracturing the multiple parallel rupturable areas 176 thereby exposes a haptically smooth fractured edge 58 along the laser-induced patterns 138.

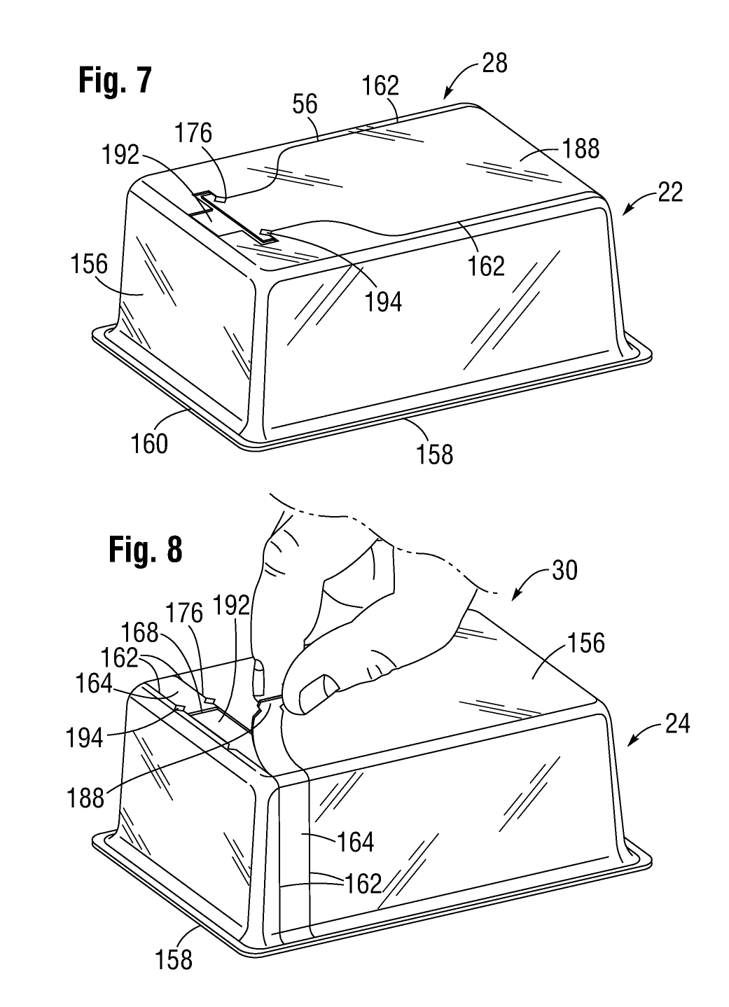

As best seen in FIG. 6 a top view of a die cutout 190 in the plastic container material 110 comprising an initiating notch or void 194 for concentrating initiating force 168 connectably attached 176 to the laser-induced rupturable patterns 138, 162 thereby imparting configuration for separating the container 110 pattern in accordance with FIGS. 5 and 7.

As shown in FIG. 7 there is shown a perspective view of a clamshell container upper portion 156 in accordance with the invention including a finger size die-cutout 192 notch or void 194 connectably attached 176 to the laser-induced rupturable pattern 138 for providing access to a pull-tab 188 in accordance with FIGS. 5 and 6.

As illustrated in FIG. 8 the thermo-formed clamshell upper portion 156 and lower portion 158 form a packaging container 120 in accordance with the invention including an attachable large die cut 190 notch or void 194, two sets of laser-induced rupturable patterns 162 for forming two transverse tear strips 164, and pull tabs 188 for separating material portions and for opening the container. The pull-tabs 188 are accessed by the user through a finger notch or void 194 and pulled to exert shearing force 122 on the attachable tear strips 164, freeing the package end to be rotated downward.

As seen in FIG. 9 a perspective view of a thermoformed clamshell package 110 wherein the lower portion 158 is welded 160 to the upper portion 156 by using thermal or radio-frequency. Two parallel rupturable patterns 162 on the upper portion shell 156 are disposed such that two parallel patterns configure a tear strip 164 for encompassing a portion 180 of the flange 202 rim 200 perimeter of the packaging material. Two short parallel rupturable patterns 162 on the upper portion shell 156 are disposed such that two parallel patterns configure tear strip ends 166 or a pull-tab ends 186. A rupturable area is disposed attachably to the short pattern ends 166 and the tear strip 164. When the user flexes the flange 202, the exposed end of the initial pull-tab 186 can be grasped, pulled upward, and the shearing force 122 applied by the user “zips” the tear strip 164 off the package perimeter 182. This “zipper” pull tab 188 provides direct access to the laser-induced pattern 164 and enables opening of the container with the force of a user's hands 122 and for imparting to the user a haptically smooth fractured edge 114 along the laser-induced fracturable plane 138.

Although there has been hereinabove described a thermoplastic container with laser-induced fracturable planes for manual opening in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A plastic material comprising:
a topside and a bottomside;
a laser energy-induced internal rupturable area disposed between the topside and the bottomside;
a pattern in structural communication with the laser-induced rupturable area, for enabling the user's hands to apply a focused shearing force on the area for fracturing and separating said material.

2. The plastic material of claim 1 wherein said rupturable area is configured such that an exerted shearing force exposes a haptically smooth fractured edge.

3. The plastic material according to claim 1 wherein two rupturable areas are disposed such that two parallel patterns configure a tear strip.

4. The plastic material according to claim 3 wherein multiple rupturable areas are disposed such that adjacently parallel and attachably disposed patterns configure a protective cover and the tear strip ends.

5. The plastic material according to claim 1 wherein multiple rupturable areas are disposed such that said pattern configures a pull-tab.

6. The plastic material according to claim 1 wherein a die cutout configured a notch or void attached to said laser-induced rupturable area.

7. The plastic material according to claim 1 wherein the plastic material is thermoformed or vacuum-formed selected from the group comprising of: polyvinyl chloride, polyethylene terephthalate, and glycol modified polyethylene terephthalate.

8. A plastic container comprising:
a topside and a bottomside of plastic material;
an upper shell portion and a lower shell portion;
a laser energy-induced internal rupturable area disposed between the topside and the bottomside;
a pattern in structural communication with the laser-induced rupturable area for enabling the user's hands to apply a focused shearing force on the area for fracturing and opening said material.

9. The plastic container of claim 8 wherein said rupturable area is configured such that an exerted shearing force exposes a haptically smooth fractured edge.

10. The plastic container according to claim 8 wherein two rupturable areas are disposed such that two parallel patterns configure a tear strip for encompassing the perimeter of the plastic container.

11. The plastic container according to claim 8 wherein two rupturable areas are disposed such that two parallel patterns configure a tear strip for encompassing a portion of the perimeter of the plastic container.

12. The plastic material according to claim 8 wherein multiple rupturable areas are disposed such that adjacently parallel and attachably disposed patterns configure a protective cover and the tear strip ends.

13. The plastic container according to claim 8 wherein multiple rupturable areas are disposed such that said pattern configures a pull-tab.

14. The plastic container according to claim 8 wherein a die cutout configured a notch or void attached to said laser-induced rupturable area.

15. The plastic container according to claim 8 wherein the plastic material is thermoformed or vacuum-formed clamshell container package selected from the group comprising of: polyvinyl chloride, polyethylene terephthalate, and glycol modified polyethylene terephthalate.

16. A method of producing a thermoformed or vacuum-formed plastic container packaging having an upper shell portion and a lower shell portion, comprising the steps of:
applying laser energy for inducing an internal rupturable area disposed between the topside and the bottomside of said plastic container material;
communicating structurally a pattern with the laser-induced rupturable area for enabling the user's hands to apply a focused shearing force on the area for fracturing and opening said material;
exerting a shearing force on said configured rupturable area for exposing a haptically smooth fractured edge;
encompassing the perimeter of the plastic container with a tear strip configured by two parallel patterns;
forming a protective cover and tear strip ends by configuring adjacently parallel and attachably disposed patterns;
forming a pull-tab by configuring said parallel patterns;
configuring a notch or void die cutout attached to laser-induced rupturable areas.

17. The method of claim 17 wherein said perimeter of the plastic container with a tear strip configured by two parallel patterns is partially encompassed.
